(19) United States
(12) Patent Application Publication
(10) Pub. No.: US 2026/0225594 A1
(43) Pub. Date: Aug. 6, 2026

(54) AUTONOMOUS DRIVING VEHICLE

(71) Applicant: TOYOTA JIDOSHA KABUSHIKI KAISHA, Toyota-shi (JP)

(72) Inventors: Tetsuya MORINO, Susono-shi (JP); Hiroto MURATA, Nagoya-shi (JP)

(73) Assignee: TOYOTA JIDOSHA KABUSHIKI KAISHA, Toyota-shi (JP)

(21) Appl. No.: 19/396,852

(22) Filed: Nov. 21, 2025

(30) Foreign Application Priority Data
Jan. 20, 2025 (JP) 2025-007519

(51) Int. Cl. B60W 30/165; B60W 30/182; B60W 60/00

(52) U.S. Cl. CPC B60W 30/165; B60W 30/182; B60W 60/00274; B60W 2520/06; B60W 2540/18; B60W 2554/4041; B60W 2554/4042; B60W 2554/802

(57) ABSTRACT

An autonomous driving vehicle following a lead vehicle includes a controller. The controller is configured to determine a target turning index based on a relative position between an own vehicle and the lead vehicle at each point in time. The controller is configured to steer a wheel based on the target turning index. The controller is configured to determine the target turning index at a certain point in time by a weighted sum of (a) a first turning index determined based on the relative position to the lead vehicle at the certain point in time and (b) a second turning index determined based on a travel trajectory of the lead vehicle up to the certain point in time.

### REFERENCE TO RELATED APPLICATIONS

This application claims priority from Japanese Patent Application No. 2025-007519 filed on Jan. 20, 2025. The entire content of the priority application is incorporated herein by reference.

### TECHNICAL FIELD

The present disclosure relates to an autonomous driving vehicle capable of following a vehicle.

### BACKGROUND ART

When a vehicle as a following vehicle follows another vehicle as a lead vehicle, for example, a technique described in Japanese Laid-Open Patent Publication No. 2017-65473 is used. The technique controls a driving of the following vehicle based on a traveling trajectory of the lead vehicle obtained by buffering.

### SUMMARY

The travel trajectory of the lead vehicle obtained according to the technology described in Japanese Laid-Open Patent Publication No. 2017-65473 has a problem with low reliability, for example, immediately after the lead vehicle starts. There is much room for improvement in a technology for making a vehicle follow another vehicle, and it is possible to improve practicability of an autonomous driving vehicle by making some improvements. It is an object of the present disclosure to provide an autonomous driving vehicle having high practicability.

An aspect of the present disclosure relates to an autonomous driving vehicle following a lead vehicle. The autonomous driving vehicle includes a controller. The controller is configured to determine a target turning index based on a relative position between an own vehicle and the lead vehicle at each point in time. The target turning index is a target of a turning index of the own vehicle. The lead vehicle leads the own vehicle. The controller is configured to steer a wheel based on the target turning index. The controller is configured to determine the target turning index at a certain point in time by a weighted sum of (a) a first turning index determined based on the relative position to the lead vehicle at the certain point in time and (b) a second turning index determined based on a travel trajectory of the lead vehicle up to the certain point in time.

According to the autonomous driving vehicle of the present disclosure, since the target turning index is determined by the weighted sum of the two turning indices, it is possible to appropriately follow the lead vehicle depending on a situation, for example.

The autonomous driving vehicle (hereinafter sometimes referred to as the “Autonomous Driving Vehicle” or simply as the “Vehicle”) of the present disclosure may not be a vehicle capable of only autonomous driving, but may be operated by remote control, for example, or may be a vehicle capable of being driven by a driver, that is, manually driven.

If a control for following another vehicle is called a “following travel control”, the present vehicle executes the following travel control as a kind of an autonomous driving control. The following travel control may include not only the control (hereinafter, it may be sometimes referred to as a “turning control”) described above, that is, a steering control for steering the wheel, but also an “inter-vehicle distance control” which is a control of a distance between the lead vehicle and an own vehicle, in other words, a braking-driving force control for controlling a braking-driving force (which is a concept in which a driving force and a braking force are integrated) applied to the own vehicle.

An object to be followed in the following travel control (hereinafter, it may be sometimes referred to as “the present following running control”) executed by the present vehicle is the “lead vehicle”. The lead vehicle is not limited to a vehicle (hereinafter, it is sometimes referred to as an “immediately-lead vehicle”) traveling immediately ahead. If a vehicle following the lead vehicle is called a “following vehicle”, another following vehicle may exist between the lead vehicle and the present vehicle. This mode is, for example, a mode in which a plurality of following vehicles follow the lead vehicle in formation. From a viewpoint of good following, it is desirable that the lead vehicle is the immediately-lead vehicle. From this viewpoint, in the present disclosure, there will be mainly described a case in which the lead vehicle is the immediately-lead vehicle, in other words, a case in which the following vehicle follows the immediately-lead vehicle.

The lead vehicle in the following travel control may be an autonomous vehicle, a remotely controlled vehicle, or a vehicle driven by a driver. The “relative position to the lead vehicle” in the following travel control is a concept including a distance between the lead vehicle and the own vehicle and a relative bearing between the lead vehicle and the own vehicle. The “relative bearing” is a parameter indicating a direction in which the lead vehicle is positioned with respect to the present vehicle, that is, with respect to the own vehicle, and specifically, it can be considered to be an angle formed by a longitudinal axis of the own vehicle and a line connecting the lead vehicle and the own vehicle (hereinafter, it is sometimes referred to as a “lead vehicle direction line”). The relative position may be obtained by a general method using a sensor provided in the own vehicle, for example, a LiDAR, a millimeter-wave radar, a camera, or the like. Reference points for the relative position of the lead vehicle and the own vehicle are not particularly limited. In view of positioning the lead vehicle by the sensor provided in the own vehicle, the reference point of the lead vehicle may be, for example, a point at a center of a rear end surface of the lead vehicle. In other words, the lead vehicle may be positioned using that point as a point of interest. The reference point of the present vehicle, that is, the reference point of the own vehicle, may be, for example, set at a point where a center of gravity of the own vehicle exists in view of the fact that the following travel control is a control of the own vehicle's own travel.

Specifically, the above-described inter-vehicle distance control may be performed such that, for example, a target inter-vehicle distance as a target distance between the lead vehicle and the own vehicle is determined, and the braking-driving force is controlled so that an actual inter-vehicle distance becomes the target inter-vehicle distance. The target inter-vehicle distance may be determined based on a traveling speed of the own vehicle or the lead vehicle in consideration of a possibility of rear-end collision by the own vehicle with the lead vehicle. On the other hand, as described above, the turning control is a control in which a target steering amount is determined based on the target turning index, and the wheels are steered such that an actual steering amount becomes the target steering amount. The “target turning index” is not particularly limited as long as the target steering amount can be determined. For example, a yaw rate of the own vehicle, a turning curvature of the own vehicle, a turning radius of the own vehicle, or the like may be adopted. From the viewpoint that the target steering amount can be determined by a relatively simple process, the turning index is preferably the turning curvature or the turning radius. Incidentally, since the turning curvature can be defined as a reciprocal of the turning radius, determining the steering amount based on the turning radius and determining the steering amount based on the turning curvature have the same meaning. It is noted that the turning control may be performed at all times, including the time of straight travel, since the straight travel of the vehicle can be considered as a turning in which the steering amount of the wheels becomes zero.

In the turning control in the present following travel control, two turning indices, a “first turning index” and a “second turning index”, are set as the turning indices. As described above, the first turning index is a turning index determined based on only a relative position to the lead vehicle at a certain point in time. That is, it is a turning index determined only by a positional relationship between the lead vehicle and the own vehicle at each point in time. On the other hand, the second turning index is a turning index determined based on the travel trajectory of the lead vehicle up to that point in time. That is, it is a turning index for turning the own vehicle so as to trace the travel trajectory of the lead vehicle. Incidentally, when determining the second turning index, the travel trajectory of the lead vehicle may be estimated by, for example, performing interpolation processing or the like based on the relative position to the lead vehicle and changes in a traveling position and a direction of the own vehicle at each point in time, as will be described later in detail.

The turning control with the first turning index as the target turning index (hereinafter, it is sometimes referred to as a “turning basic control”) has a problem that, for example, as described later, an IN-cut phenomenon, that is, a phenomenon of the present vehicle turning on the inside of the lead vehicle's turning path, occurs. On the other hand, in the control with the second turning index as the target turning index (hereinafter, it may be sometimes referred to as a “trace turning control”), it is assumed that, for example, as described later, the reliability of control, specifically, the reliability of estimation of the travel trajectory of the lead vehicle, becomes low. For example, when a travel distance per time of the lead vehicle is small, such as when starting, that is, when a traveling speed of the lead vehicle is low, it is considered highly likely that the travel trajectory cannot be estimated with high accuracy.

Therefore, in the present autonomous vehicle, the target turning index is determined by weighting and adding the first turning index and the second turning index in the turning control. In the present vehicle, the weighting of the first turning index and the second turning index may be changeable. More specifically, for example, the weighting may be changed based on the reliability of the second turning index. Specifically, the reliability may be estimated based on a change amount in a traveling position of the lead vehicle. Specifically, the reliability may be considered to be higher when the change amount in the traveling position of the lead vehicle (the change amount per time) is large. Therefore, for example, the weighting of the second turning index may be increased when the change amount in the traveling position of the lead vehicle is large. From another viewpoint, since it can be considered that the traveling speed of the lead vehicle is generally high when motion of the lead vehicle is large, the weighting may be changed based on the traveling speed of the lead vehicle. Specifically, the weighting of the second turning index may be increased when the traveling speed of the lead vehicle is high. Further, in accordance with the change amount in the traveling position of the lead vehicle and the traveling speed of the lead vehicle, the weighting of the second turning index may be increased as the change amount is large and the traveling speed of the lead vehicle is large.

The weighting may be changed by switching between two modes. That is, a first mode and a second mode may be set to be switchable, and, for example, one mode of the first mode and the second mode may be adopted in which the weighting of the second turning index is made smaller in the one mode than in the other mode. In this case, for example, the first mode may be adopted when the reliability of the determined second turning index is less than a set level, and the second mode may be adopted when the reliability of the determined second turning index is equal to or greater than the set level. From another viewpoint, the first mode may be adopted when the traveling speed of the lead vehicle is less than a set speed, and the second mode may be adopted when the traveling speed of the lead vehicle is greater than or equal to the set speed.

Regardless of whether the two modes are adopted, the weighted sum of the first turning index and the second turning index may be obtained by, for example, multiplying the first turning index and the second turning index by a first weighting coefficient and a second weighting coefficient whose sum is 1, respectively, and adding the multiplied values. Increasing the first weighting coefficient increases the weighting of the first turning index, and increasing the weighting of the second weighting coefficient increases the weighting of the second turning index.

When the two modes are adopted and the first weighting coefficient and the second weighting coefficient are adopted, specifically, for example, in the first mode, the first weighting coefficient may be 1 and the second weighting coefficient may be 0, and in the second mode, the first weighting coefficient may be 0 and the second weighting coefficient may be 1. Further, in consideration of the robustness of the control, that is, from the viewpoint that the control is hardly affected by fluctuations of external factors, the first weighting factor may be set to a first set value smaller than 1 and the second weighting factor may be set to a second set value larger than 0 in the second mode. In this case, the set values may be set according to the reliability of the second turning index. Specifically, the second set value may be set to, for example, 0.5 to 0.8.

In addition, when the above two modes are adopted, it is desirable that the weighting is gradually changed so that the mode switching between the first mode and the second mode is smoothly performed. In this case, a gradient of the gradual change may be determined, for example, by at least one of the traveling speed of the own vehicle or the lead vehicle, the inter-vehicle distance between the own vehicle and the lead vehicle, and the steering amount of the wheels. Specifically, for example, the gradient may be steeper as the traveling speed is higher, the inter-vehicle distance is larger, or the steering amount is larger. Conversely, the gradient may be looser as the traveling speed is lower, the inter-vehicle distance is smaller, or the steering amount is smaller.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which;

FIG. 1 is a schematic diagram illustrating a hardware configuration of an autonomous vehicle of an embodiment;

FIG. 2 is a schematic diagram illustrating a basic following travel control performed in the autonomous vehicle of the embodiment;

FIG. 3 is a diagram illustrating an IN-cut phenomenon that occurs when following a vehicle to turn;

FIG. 4 is a schematic diagram illustrating a trace turning control performed in the autonomous vehicle of the embodiment;

FIG. 5A is a graph comparing a first turning index (a first turning curvature) and a second turning index (a second turning curvature) determined in a turning basic control and the trace turning control, respectively;

FIG. 5B is a graph showing an change amount in a position of a lead vehicle in the trace turning control;

FIG. 5C is a graph comparing the first turning index and the second turning index when a driving speed of the lead vehicle is low;

FIG. 6 is a graph schematically illustrating a target turning index determined as time passes from a start timing of the lead vehicle in the following travel control; and

FIG. 7 is a flowchart of a following travel control program performed in the autonomous vehicle of the embodiment.

### DESCRIPTION

Hereinafter, an autonomous vehicle of an embodiment of the disclosure will be described in detail with reference to the drawings as the embodiment of the disclosure. It should be noted that, in addition to the following embodiments, the present disclosure can be embodied in various other embodiments in which various modifications and improvements are made based on the knowledge of a person skilled in the art.

### Configuration of Autonomous Driving Vehicle

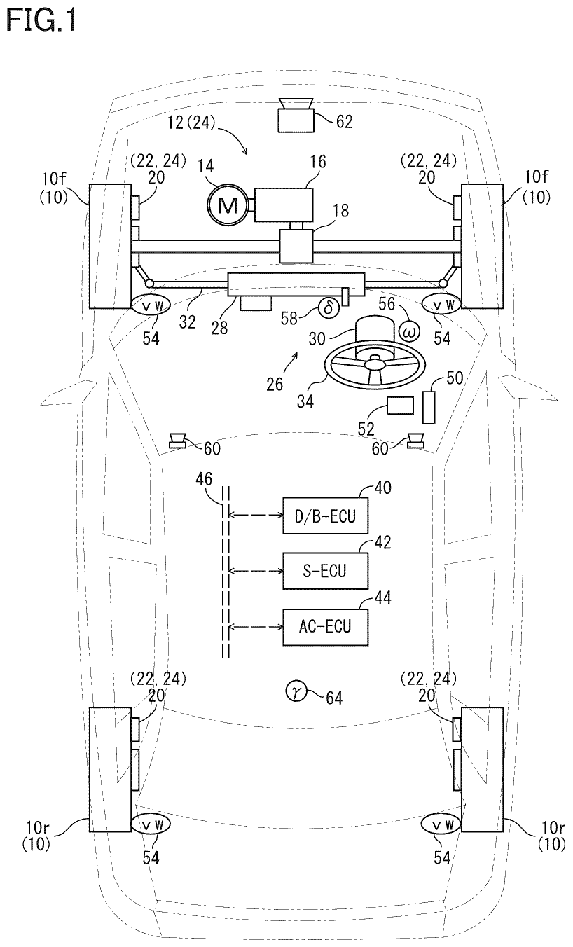

The autonomous vehicle (hereinafter sometimes referred to as an “Autonomous Driving Vehicle” or simply as a “present vehicle”) of the embodiment is a vehicle having left and right front wheels 10f and left and right rear wheels 10r, as shown schematically in FIG. 1. The front wheels 10f and the rear wheels 10r may be collectively sometimes referred to as wheels 10 when it is not necessary to distinguish between the front and rear wheels. The configuration of the present vehicle will be described below with reference to FIG. 1, but since the configuration is the same as that of a general vehicle except for a portion related to autonomous driving, which will be described later, the description will be made simply.

In the present vehicle, the front wheels 10f serve as drive wheels and are driven by a driving system 12. The present vehicle is a BEV (Battery Electric Vehicle), and the driving system 12 includes a drive motor 14 serving as a drive source, a transmission 16, a differential gear 18, and the like. Moreover, each of the four wheels 10 is provided with a wheel-brake-device 20. Each wheel-brake-device 20 is a general electric brake device and uses an electric motor as a drive source, although detailed description and illustration are omitted. The four wheel-brake-devices 20 constitute one braking system 22 of the present vehicle. Moreover, the driving system 12 and the braking system 22 constitute one braking-driving system 24 of the present vehicle.

In the present vehicle, the front wheels 10f are steering wheels, and a steering device 26 for steering the front wheels 10f is provided. The steering device 26 is a steer-by-wire type steering device, and has a steering actuator 28 and a reaction force actuator 30 mechanically separated from each other. The steering actuator 28 has a steering motor as a drive source, and the force of the steering motor causes a steering rod (rack bar) 32 to which the left and right front wheels 10f are respectively connected at left and right ends to move left and right, so that the left and right front wheels 10f are steered together. The reaction force actuator 30 holds a steering wheel 34 which is a steering operation member, and has a reaction force motor as a drive source to apply an operation reaction force to the steering wheel 34 against the operation of the steering wheel 34.

The present vehicle is equipped with a braking-driving electronic control unit 40 for controlling the braking-driving system 24, a steering electronic control unit 42 for controlling the steering device, and an autonomous driving electronic control unit 44 for executing the autonomous driving of the present vehicle, which are connected to a CAN (Controllable Area Network or Car Area Network) 46. Hereinafter, these units may be sometimes referred to as the braking-driving ECU 40, the steering ECU 42, and the autonomous driving ECU 44. Incidentally, the braking-driving ECU 40 includes a computer, the drive motor 14, a driver (drive circuit) of an electric motor of each of the wheel-brake-devices 20, and the like, the steering ECU 42 includes a computer, a driver of a steering motor, a driver of a reaction force motor, and the like, and the autonomous driving ECU 44 includes a computer as a main component. It is noted that these ECUs 40, 42, and 44 constitute one controller of the present vehicle.

Moreover, the present vehicle is provided with an accelerator pedal 50 as an accelerator operating member and a brake pedal 52 as a brake operating member, which are also connected to the CAN 46. In addition, the present vehicle is provided with, as sensors, wheel speed sensors 54 each for detecting a rotational speed (hereinafter, sometimes referred to as a “wheel speed”) vw of each wheel 10, an operation angle sensor 56 for detecting an operation angle ω of the steering wheel 34 as a steering operation amount, a steering angle sensor 58 for detecting a steering angle δ of the front wheel 10f as a steering amount, two cameras 60 and a millimeter-wave radar 62 for monitoring the front of the vehicle, and a yaw rate sensor 64 for detecting a yaw rate γ. These sensors are also connected to the CAN 46. It is noted that, in present vehicle, the steering angle δ is detected as a movement amount in a left and right direction of the steering rod 32.

The present vehicle is capable of manual driving, that is, the present vehicle can be driven by a driver. Briefly, in the manual driving, the braking-driving ECU 40 determines a driving force Fd to be applied to the present vehicle based on an operation amount of the accelerator pedal 50, and controls the driving system 12 based on the driving force Fd. Further, the braking-driving ECU 40 determines a braking force Fb to be applied to the present vehicle based on an operation amount of the brake pedal 52, controls regenerative braking by the driving system 12 based on the braking force Fb, and controls the braking system 22 to generate a supplemental amount of the braking force Fb that is insufficient in the regenerative braking. Incidentally, the braking-driving ECU 40 has a function of detecting a traveling speed of the own vehicle (hereinafter, it is sometimes referred to as an “own vehicle speed”) vo based on the wheel speed vw of each of the wheels 10. It is noted that, in the following description, a combination of the driving force Fd and the braking force Fb is treated as a braking-driving force Fd/b.

Further, in the manual driving, the steering ECU 42 determines a target steering angle δ*, which is a target of the steering angle δ of the front wheel 10f, based on the operation angle ω of the steering wheel 34 according to the following equation:

δ*=η·ω η: steering gear ratio

The steering ECU 42 controls the steering device 26 so that an actual steering angle δ becomes the target steering angle δ*.

### Following Travel Control

The present vehicle also performs autonomous driving not dependent on the operation of the driver. An autonomous driving control, which is a control for the autonomous driving, is executed by the autonomous driving ECU 44. When following the lead vehicle, the autonomous driving ECU 44 executes a following travel control (hereinafter, it may be sometimes referred to as the “present following travel control”) as a type of autonomous driving control. The following travel control will be described in detail below, but first, a following travel basic control which is the basis of the following travel control will be described, and then, the contents of the present following travel control will be described in order.

### Following Travel Basic Control

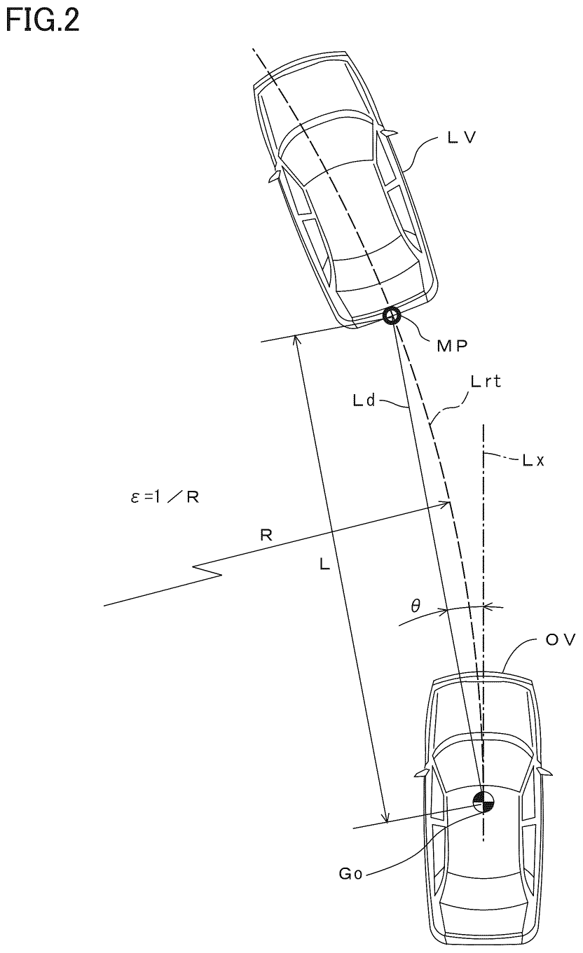

As shown in FIG. 2, the autonomous driving ECU 44 basically obtains a relative position between a lead vehicle LV and the present vehicle (hereinafter sometimes referred to as the “own vehicle”) OV which is the following vehicle, and executes the following travel control based on the relative position. The relative position includes an inter-vehicle distance L between the lead vehicle LV and the own vehicle OV and a relative-bearing angle θ which is a relative bearing. The relative-bearing angle θ is a parameter indicating a direction in which the lead vehicle LV is positioned relative to the own vehicle. More specifically, the autonomous driving ECU 44 specifies a point of interest MP as a reference for the relative position of the lead vehicle LV from information obtained by the two cameras 60 and the millimeter-wave radar 62, and measures the inter-vehicle distance L as a distance between the point of interest MP and a position of a center of gravity Go as a reference for the own vehicle OV. Further, the autonomous driving ECU 44 specifies a lead vehicle direction line Ld as a line connecting the point of interest MP and the position of the center of gravity Go, and measures an angle formed by the lead vehicle direction line Ld and a longitudinal axis line Lx of the own vehicle OV as the relative-bearing angle θ. Incidentally, the point of interest MP is set at a center of a rear end surface of the lead vehicle LV.

In the present following travel control, a turning curvature ε is adopted as an index for turning of the own vehicle OV, that is, as a turning index, and the autonomous driving ECU 44 then determines a turning travel line Lrt, which is a travel line Lr for moving the own vehicle OV at the current time to the position of the lead vehicle LV at the current time in turning, based on the inter-vehicle distance L and the relative-bearing angle θ, and determines the turning curvature ε of the turning travel line Lrt as a target turning curvature ε*. Incidentally, the turning curvature ε is an inverse of a turning radius R. The obtainments of the inter-vehicle distance L and the relative-bearing angle θ and the determination of the target turning curvature ε* are performed at each point in time. Specifically, they are iteratively performed at a set positioning time pitch Δtm (for example, tens of msec to hundreds of msec).

The following travel control includes an inter-vehicle distance control for controlling the inter-vehicle distance L between the lead vehicle LV and the own vehicle OV, and a turning control for turning the own vehicle OV. The inter-vehicle distance control may be referred to as a braking-driving force control for controlling the braking-driving force Fd/b applied to the own vehicle OV, and the turning control may be referred to as a steering angle control for controlling the steering angle δ of the front wheel 10f of the own vehicle OV. Since the concept of turning includes a case in which the steering angle δ becomes 0, that is, a state in which the vehicle is traveling straight, the turning control is also executed when the vehicle is traveling straight. Incidentally, the target turning curvature ε* when the vehicle is traveling straight and following is determined to be 0.

In the inter-vehicle distance control, the braking-driving force Fd/b is controlled so that the inter-vehicle distance L becomes a target inter-vehicle distance L*. More specifically, the autonomous driving ECU 44 specifies the own vehicle speed vo detected by the braking-driving ECU 40 as described above, and specifies a lead vehicle speed vl, which is the traveling speed of the lead vehicle LV, based on the own vehicle speed vo and an inter-vehicle distance change speed (dL/dt), which is a change speed of the inter-vehicle distance L, according to the following equation:

vl=vo+(dL/dt)·Δt

The target inter-vehicle distance L* is determined to be larger as the lead vehicle speed vl increases in consideration of the possibility of rear-end collision by the own vehicle OV with the lead vehicle LV, using a vehicle speed-dependent determination coefficient ξ, according to the following equation:

L*=L0+ξ·vl L0: Reference Inter-vehicle Distance

The autonomous driving ECU 44 determines the braking-driving force Fd/b to be applied to the own vehicle OV according to a PD feedback control law, specifically according to the following equation, based on an inter-vehicle distance deviation ΔL (=L*−L) which is a deviation of the actual inter-vehicle distance from the determined target inter-vehicle distance L*.

Fd/b=βp·ΔL+βd·(dΔL/dt)

Note that βp is a proportional term gain and βd is a differential term gain.

The autonomous driving ECU 44 transmits information indicating the determined braking-driving force Fd/b to the braking-driving ECU 40, and the braking-driving ECU 40 controls the braking-driving system 24, more specifically, the driving system 12 and the braking system 22, based on the braking-driving force Fd/b as in the case of the manual driving described above. Specifically, when the braking-driving force Fd/b is positive, the braking-driving ECU 40 controls the driving system 12 based on the braking-driving force Fd/b as the driving force Fd to be applied, and when the braking-driving force Fd/b is negative, the braking-driving ECU 40 generates the regenerative braking force in the driving system 12 and controls the braking system 22 to generate a supplemental amount that is insufficient in the regenerative braking force based on the braking-driving force Fd/b as the braking force Fb to be applied.

In the turning control in the following travel basic control (hereinafter, it is sometimes referred to as a “turning basic control”), the autonomous driving ECU 44 adopts the turning curvature ε determined as described above as the target turning curvature ε* (a kind of a target turning index). Based on the target turning curvature ε*, the autonomous driving ECU 44 determines the target steering angle δ* which is the steering angle δ of the front wheel 10f to be realized, and transmits information about the target steering angle δ* to the steering ECU 42. The steering ECU 42 controls the steering actuator 28 so that the actual steering angle δ becomes the target steering angle δ*. It is noted that the process for determining the braking-driving force Fd/b and the process for determining the target steering angle δ* may be repeated at a set control time pitch Δtc(for example, several msec to several tens of msec).

### Problems in Turning Basic Control

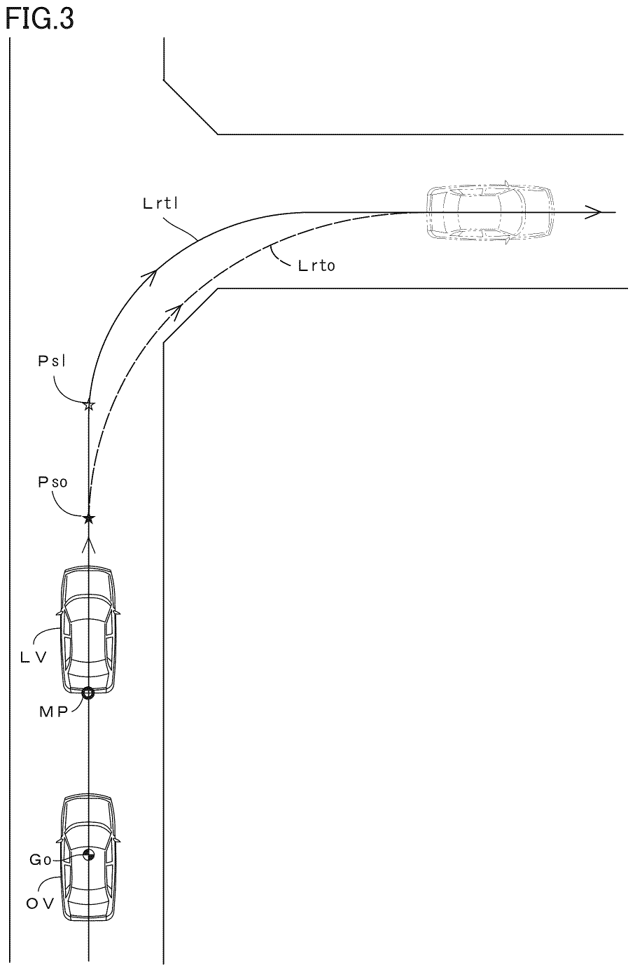

When the turning basic control described above is executed, an IN-cut phenomenon occurs. The IN-cut phenomenon is a phenomenon in which, as shown in FIG. 3, when the own vehicle OV follows the turning lead vehicle LV and turns, the own vehicle OV travels on an own vehicle turning travel line Lrto which is positioned inside a lead vehicle turning travel line Lrtl. The lead vehicle turning travel line Lrtl is the turning travel line Lrt when the lead vehicle LV turns. The own vehicle turning travel line Lrto is the turning travel line Lrt that is positioned inside the lead vehicle turning travel line Lrtl. To put it simply, this phenomenon is caused by the fact that the relative-bearing angle θ deviates from 0 at the timing when the lead vehicle LV starts turning, and the own vehicle OV also starts turning at that time. Specifically, this is because the lead vehicle LV starts turning from a lead vehicle turning start position Psl indicated by a “white star symbol”, while the own vehicle OV starts turning from an own vehicle turning start position Pso indicated by a “black star symbol”.

Due to the above-described IN-cut phenomenon, the own vehicle OV cannot properly follow the vehicle when turning. In an extreme case, the IN-cut phenomenon may cause the own vehicle OV to interfere with an object such as a structure existing inside the turning. Therefore, in the present vehicle, in order to cope with the problem caused by the IN-cut phenomenon, a trace turning control, which is another turning control, can be executed instead of the turning basic control.

### Trace Turning Control

In the trace turning control, simply put, the autonomous driving ECU 44 controls the own vehicle OV so that the own vehicle OV turns on the lead vehicle turning travel line Lrtl, which is a traveling locus of the lead vehicle LV. As described above, in the turning basic control, the autonomous driving ECU 44 determines the turning travel line Lrt of the own vehicle OV based only on the relative positions of the own vehicle OV to the lead vehicle LV at the current time, that is, the inter-vehicle distance L and the relative-bearing angle θ, and determines the turning curvature ε of the turning travel line Lrt to be the target turning curvature ε*. On the other hand, in the trace turning control, the autonomous driving ECU 44 estimates the lead vehicle turning travel line Lrtl, which is the travel line of the lead vehicle LV, based on the relative positions of the own vehicle OV to the lead vehicle LV, the traveling position of the own vehicle OV and a direction change of the own vehicle OV at each point in time.

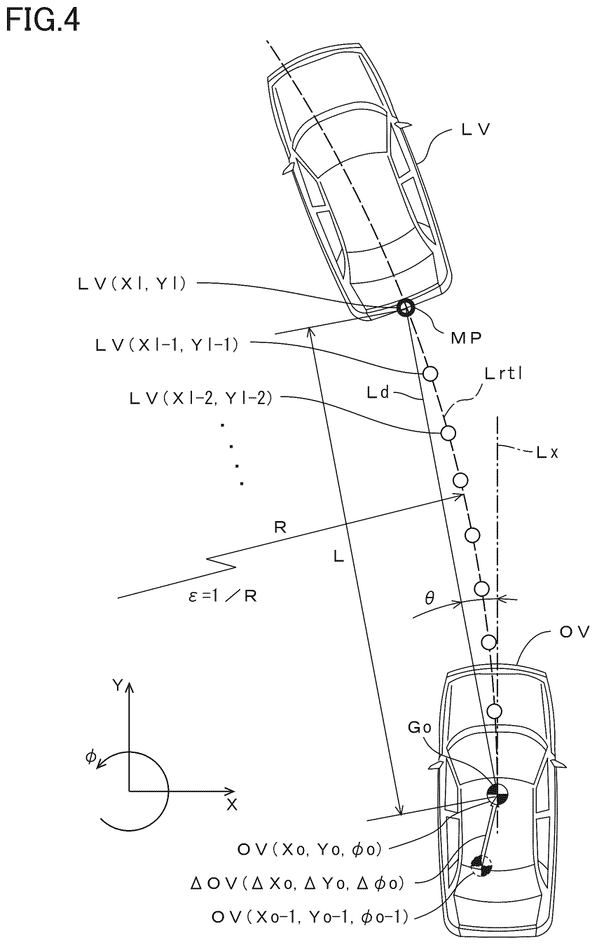

Referring to FIG. 4, in the trace turning control, the position and the direction of the own vehicle OV and the position of the lead vehicle LV are defined on XY two-dimensional coordinates. Specifically, the position (position of the center of gravity Go) and the direction of the own vehicle OV are defined as OV (Xo, Yo, φo), and the traveling position (position of the point of interest MP) of the lead vehicle LV is defined as position LV (Xl, Yl). Similar to the turning basic control, the inter-vehicle distance L and the relative-bearing angle θ between the own vehicle OV and the lead vehicle LV are measured at each positioning time pitch Δtm, and the position (traveling position) and direction OV (Xo, Yo, φo) of the own vehicle OV and the position LV (Xl, Yl) of the lead vehicle LV are specified at each positioning time pitch Δtm.

More specifically, the autonomous driving ECU 44 obtains a change amount ΔOV (ΔXo, ΔYo, Δφo) from the position and direction OV (Xo−1, Yo−1, φo−1) of the own vehicle OV specified the previous time based on the braking-driving force Fd/b applied to the own vehicle OV and the steering angle δ of the front wheel 10f. By adding the change amount ΔOV (ΔXo, ΔYo, Δφo), the current position and direction OV (Xo, Yo, φo) of the own vehicle OV are specified. Then, the autonomous driving ECU 44 specifies the current position LV (Xl, Yl) of the lead vehicle LV, that is, the current position at that time based on the position and direction OV (Xo, Yo, φo) and the inter-vehicle distance L and the relative-bearing angle θ between the own vehicle OV and the lead vehicle LV at that time.

The autonomous driving ECU 44 stores the previous position LV (Xl−1, Yl−1) and the preceding positions LV (Xl−2, Yl−2) . . . , which are the positions prior to the previous time of the lead vehicle LV for a set time (for example, a few seconds), that is, for a set number of positions. The autonomous driving ECU 44 determines the lead vehicle turning travel line Lrtl of the lead vehicle LV by performing an interpolation process to the current position LV (Xl, Yl), the previous position LV (Xl−1, Yl−1) and the preceding positions LV (Xl−2, Yl−2) . . . . In the trace turning control, the autonomous driving ECU 44 determines the target turning curvature ε* based on the lead vehicle turning travel line Lrtl. Similar to the turning basic control, the autonomous driving ECU 44 determines the target steering angle δ* based on the target turning curvature ε* and transmits information about the target steering angle δ* to the steering ECU 42.

The target turning curvature ε* in the trace turning control can be called a spline curvature because the interpolation process is performed in determining the lead vehicle turning travel line Lrtl, and the target turning curvature ε* in the turning basic control can be called a point-of-interest curvature because the target turning curvature ε* is determined based on the point of interest MP of the lead vehicle LV at each point in time. Accordingly, the target turning curvature ε* in the turning basic control will hereinafter be called a point-of-interest curvature ε1* as a first turning index, and the target turning curvature ε* in the trace turning control will be called a spline curvature ε2* as a second turning index.

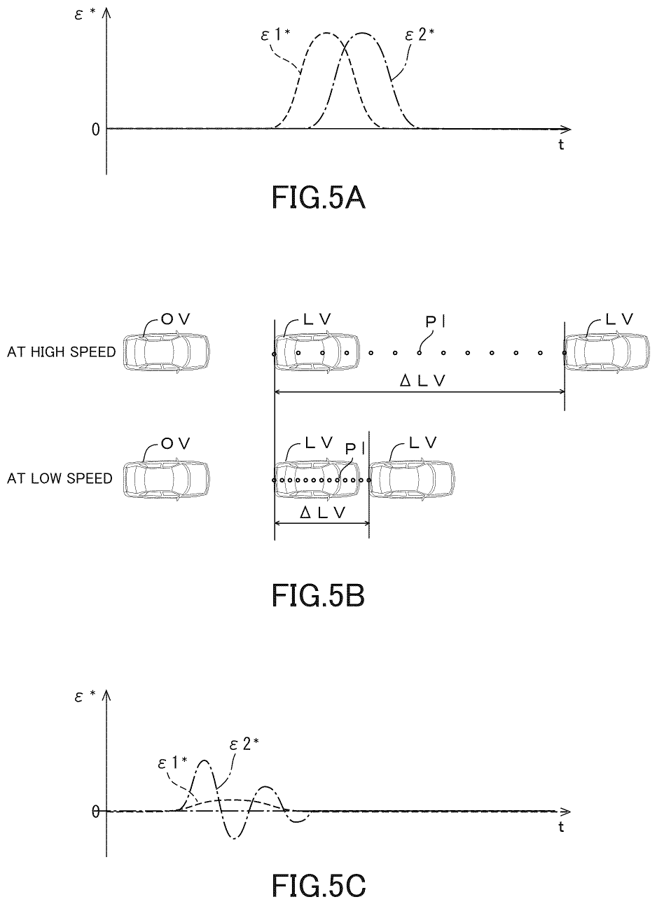

When the point-of-interest curvature ε1* and the spline curvature ε2* in turning are compared in terms of changes over time, the changes can be schematically shown as graphs in FIG. 5A. Briefly, the spline curvature ε2* shown by a dash-dot line is obtained by delaying the point-of-interest curvature ε1* shown by a dashed line. Therefore, according to the trace turning control, the own vehicle OV can turn along the lead vehicle turning travel line Lrtl and avoid the above-described IN-cut phenomenon.

### Problems in Trace Turning Control

However, the spline curvature ε2* may have low reliability. As described above, the autonomous driving ECU 44 determines the lead vehicle turning travel line Lrtl which is the traveling trajectory of the lead vehicle LV and the spline curvature ε2* is determined based on the lead vehicle turning travel line Lrtl. Therefore, for example, when the movement of the lead vehicle LV is small, the accuracy of the determined lead vehicle turning travel line Lrtl is low, and as a result, the accuracy of the spline curvature ε2*, that is, the reliability is low.

As shown schematically in FIG. 5B, for example, when the lead vehicle speed vl which is the traveling speed of the lead vehicle LV is low, such as when the stopping lead vehicle LV starts, a change amount ΔLV (ΔXl, ΔYl) of the traveling position LV (Xl, Yl) of the lead vehicle LV is small as compared with a case where the lead vehicle is traveling at a relatively high lead vehicle speed vl. Here, the change amount ΔLV (ΔXl, ΔYl) is a change amount per time during which the position LV (Xl, Yl) of the lead vehicle LV is being stored (the time is a set multiple of the positioning time pitch Δtm, for example, several seconds). That is, a group of points Pl on which the position LV (Xl, Yl) of the lead vehicle is plotted is in a dense state. In other words, the change amount ΔLV (ΔXl, ΔYl) which is the point group distance is small. Therefore, for example, in a case where the lead vehicle LV makes a relatively small turn (such that the lead vehicle is shifted to either left or right), an estimation accuracy of the lead vehicle turning travel line Lrtl of the lead vehicle becomes particularly low, and as schematically shown in graphs of FIG. 5C, the spline curvature ε2* shown by the dash-dot line is greatly disturbed, unlike the point-of-interest curvature ε1* shown by the broken line. That is, according to the trace turning control, when the reliability of the spline curvature ε2* becomes low, the behavior of the own vehicle OV, which is the following vehicle, becomes disturbed. Incidentally, in the figure, the change amount ΔLV (ΔXl, ΔYl) is expressed as the change amount ΔLV. Similarly, in the following description, the change amount ΔLV (ΔXl, ΔYl) may be expressed simply as the change amount ΔLV.

### Determination of Target Turning Curvature by Weighted Sum

In view of the foregoing description, in the present following travel control, the autonomous driving ECU 44 determines the target turning curvature ε* by a weighted sum of the point-of-interest curvature ε1* as the first turning index and the spline curvature ε2* as the second turning index in the turning control. Specifically, the autonomous driving ECU 44 sets a first weighting coefficient K and a second weighting coefficient (1−K) whose sum is 1, and determines the target turning curvature ε* according to the following equation:

ε*=K·ε1*+(1−K)·ε2* 0≤K≤1

More specifically, in the present following travel control, the first weighting coefficient K and the second weighting coefficient (1−K) are changed. Briefly, the reliability of the spline curvature ε2* or the lead vehicle speed vl, which is the traveling speed of the lead vehicle LV, is adopted as a coefficient change parameter, and the autonomous driving ECU 44 changes the first weighting coefficient K and the second weighting coefficient (1−K) based on either the reliability or the lead vehicle speed vl. Since the reliability is estimated based on the change ΔLV of the position LV (Xl, Yl) of the lead vehicle LV, as described above, the change ΔLV itself is regarded as the reliability. Whether the change ΔLV or the lead vehicle speed vl is adopted as the coefficient change parameter is determined in advance based on the specifications, capabilities, and the like of the lead vehicle LV and the own vehicle OV. Briefly, regarding the change of the first weighting coefficient K and the second weighting coefficient (1−K), when the change ΔLV is relatively small or the lead vehicle speed vl is relatively low, the first weighting coefficient K is increased and the second weighting coefficient (1−K) is decreased, and when the change ΔLV is relatively large or the lead vehicle speed vl is relatively high, the first weighting coefficient is decreased and the second weighting coefficient (1−K) is increased.

More specifically, in the present following travel control, two modes of a first mode and a second mode are set, and one of the first mode and the second mode is selected. Specifically, in the first mode, the first weighting coefficient K is set to 1 and the second weighting coefficient (1−K) is set to 0. Briefly, in the first mode, the above-described turning basic control is executed. On the other hand, in the second mode, the first weighting coefficient K is set to a specific value Ks and the second weighting coefficient (1−K) is set to (1−Ks). The specific value Ks may be 0, or it may be x which is a value greater than 0 and less than 1. In short, when the specific value Ks is 0, the above-described trace turning control is executed in the second mode. When the specific value Ks is x, an intermediate turning control which is positioned between the turning basic control and the trace turning control is executed, as will be described later. The x may be determined in consideration of the robustness of the turning control in the following travel control, and is preferably a value of about 0.2~0.5, for example. In other words, the second weighting coefficient (1−K) is preferably a value of about 0.5~0.8. Although the first weighting coefficient K and the second weighting coefficient (1−K) in the second mode are set fixedly, they may be set to vary according to, for example, the lead vehicle speed vl, the own vehicle speed vo which is the traveling speed of the own vehicle OV, the inter-vehicle distance L between the own vehicle OV and the lead vehicle LV, the steering angle δ of the front wheel 10f of the own vehicle OV, and the like.

The autonomous driving ECU 44 selects either the first mode or the second mode, that is, executes mode selection, based on the change amount ΔLV or the lead vehicle speed vl which is the coefficient change parameter. More specifically, when the change amount ΔLV is used as the coefficient change parameter, the autonomous driving ECU 44 selects the first mode when the change amount ΔLV is less than a threshold change amount ΔLVth, that is, when the reliability of the spline curvature ε2* is less than a preset level, and selects the second mode when the change amount ΔLV is equal to or greater than the threshold change amount ΔLVth, that is, when the reliability of the spline curvature ε2* is equal to or greater than the preset level. When the lead vehicle speed vl is used as the coefficient change parameter, the autonomous driving ECU 44 selects the first mode when the lead vehicle speed vl is less than a threshold vehicle speed vlth, and selects the second mode when the lead vehicle speed vl is equal to or greater than the threshold vehicle speed vlth. That is, the threshold change amount ΔLVth and the threshold vehicle speed vlth are set to certain values that can recognize that the reliability of the spline curvature ε2*, which is the second turning index, is relatively high or more when the change amount ΔLV and the lead vehicle speed vl are equal to or greater than the certain values, respectively.

Moreover, in the turning control of the present following travel control, the first weighting coefficient K and the second weighting coefficient (1−K) are gradually changed in consideration of the smooth behavior of the own vehicle OV when switching between the first mode and the second mode. Specifically, the autonomous driving ECU 44 changes the first weighting coefficient K and the second weighting coefficient (1−K) according to a change gradient α (=dK/dt). The autonomous driving ECU 44 determines the change gradient α by a change gradient determination function α (vl, L, δ) using the lead vehicle speed vl (this may be the own vehicle speed vo), the inter-vehicle distance L, and the steering angle δ as parameters. According to the change gradient determination function α (vl, L, δ), the change gradient α is determined to become steeper as the lead vehicle speed vl increases, the inter-vehicle distance L increases, and the steering angle δ increases. Incidentally, when switching from the first mode to the second mode, the first weighting coefficient is decreased by (α·Δtc) for each control time pitch Δtc, and when switching from the second mode to the first mode, the first weighting coefficient is increased by (α·Δtc) for each control time pitch Δtc. It is noted that the change gradient α may be determined not based on all of the lead vehicle speed vl, the own vehicle speed vo, the inter-vehicle distance L, and the steering angle δ, but the change gradient α may be determined based on any one or more of them.

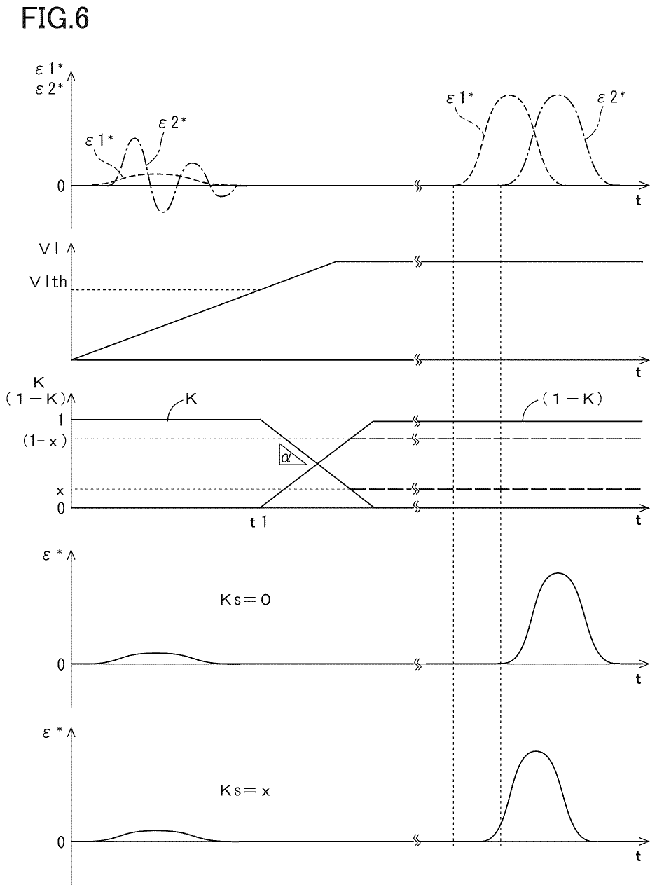

As an example, the target turning curvature ε* determined as described above is schematically shown in graphs of FIG. 6. The graphs show changes with time of the lead vehicle speed vl, the point-of-interest curvature ε1*, the spline curvature ε2*, the first weighting coefficient K, the second weighting coefficient (1−K), and the target turning curvature ε* when the own vehicle OV follows the lead vehicle LV which is starting from the stopped state. It is noted that the graph shows an example when the coefficient change parameter is the lead vehicle speed vl.

As can be seen from the graphs, the point-of-interest curvature ε1* and the spline curvature ε2* are determined to the values described above regardless of the lead vehicle speed vl. Until the lead vehicle speed vl increases to reach the threshold vehicle speed vlth, the first weighting coefficient K is 1 and the second weighting coefficient (1−K) is 0. As a result, when the lead vehicle speed vl is relatively low, the target turning curvature ε* is determined to be the point-of-interest curvature ε1*.

After the lead vehicle speed vl increases to reach the threshold vehicle speed vlth, the first weighting coefficient K is gradually decreased according to the change gradient α, and correspondingly, the second weighting coefficient (1−K) is gradually increased. When the specific value Ks is set to 0, the first weighting factor K is reduced to 0 and the second weighting factor (1−K) is increased to 1, as shown by a solid line. When the specific value Ks is set to x, the first weighting factor K is reduced to x and the second weighting factor (1−K) is increased to (1−x), as shown by a broken line.

Thereafter, when the lead vehicle LV turns in a state in which the lead vehicle speed vl exceeds the threshold vehicle speed vlth, the target turning curvature ε* is determined to be the spline curvature ε2* when the specific value Ks is set to 0, as shown in the graphs. On the other hand, when the specific value Ks is set to x, the target turning curvature ε* is determined to be an intermediate state between the point-of-interest curvature ε1* and the spline curvature ε2*. In other words, the target turning curvature ε* is determined to be a state in which the target turning curvature ε* is behind the point-of-interest curvature ε1* and ahead of the spline curvature ε2*.

In the turning control in the present following travel control, the autonomous driving ECU 44 determines the target steering angle δ* based on the target turning curvature ε* determined as described above, and transmits information about the target steering angle δ* to the steering ECU 42, as in the turning basic control and the trace turning control.

### Flow of Following Travel Control

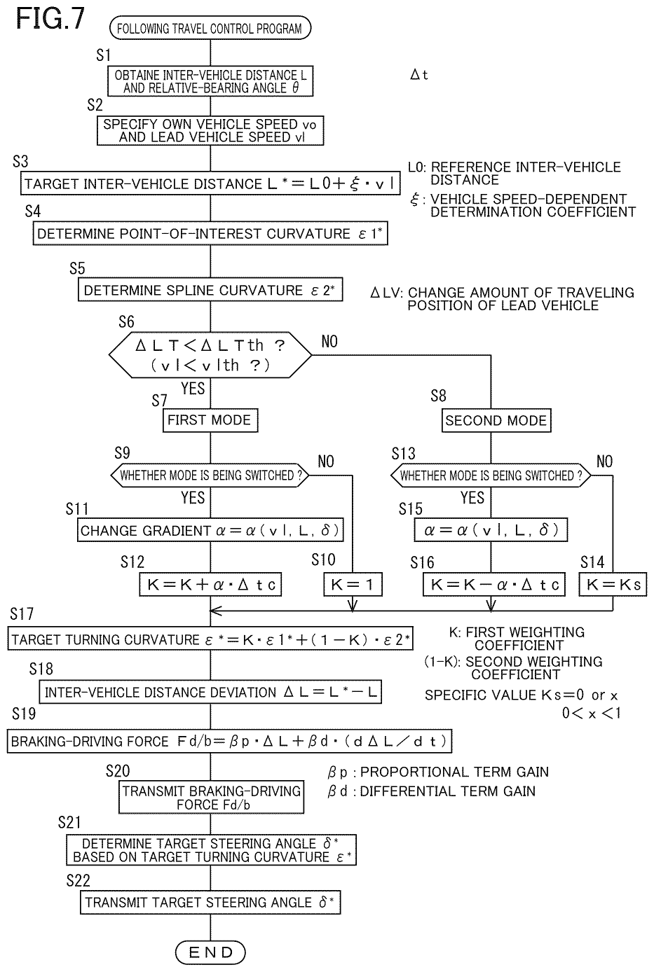

The above-described present following travel control is performed by the autonomous driving ECU 44 repeatedly executing a following travel control program shown in a flowchart in FIG. 7 at the above-described control time pitch Δtc. The flow of processing in the present following travel control will be briefly described below along the flowchart. It is noted that, in practice, the positioning of the lead vehicle LV and the determination of the spline curvature ε2* and the like are repeatedly performed at the above-described positioning time pitch Δtm, but in the following description, they are also repeatedly performed at the control time pitch Δtc to simplify the description.

In the processing according to the following travel control program, first, in step 1 (hereinafter, it is abbreviated as “S1” and the other steps are similar), the inter-vehicle distance L, which are the relative positions to the lead vehicle LV, and the relative-bearing angle θ are obtained, and in step S2, the own vehicle speed vo, which is the traveling speed of the own vehicle OV, and the lead vehicle speed vl, which is the traveling speed of the lead vehicle LV, are specified. In the subsequent step S3, the target inter-vehicle distance L* is determined based on the reference inter-vehicle distance L0, the lead vehicle speed vl, and the vehicle speed-dependent determination coefficient ξ, as described above. In the next step S4, as described above, the turning travel line Lrt along which the own vehicle OV should travel is specified based on the inter-vehicle distance L and the relative-bearing angle θ, and the point-of-interest curvature ε1* is determined. Subsequently, in step S5, as described above, the lead vehicle turning travel line Lrtl of the lead vehicle LV is determined based on the change amount ΔOV (ΔXo, ΔYo, Δφo) in the position and the direction of the own vehicle OV from the previous execution of the program, the current inter-vehicle distance L and the relative-bearing angle θ, and the spline curvature ε2* is determined based on the determined lead vehicle turning travel line Lrtl. It is noted that, as described above, each traveling position LV (Xl, Yl) of the lead vehicle LV specified in the process of determining the spline curvature ε2* is stored for the set time.

Subsequently, in step S6, the determination based on the coefficient change parameter is made as described above. More specifically, when the change amount ΔLV of the traveling position of the lead vehicle LV is used as the coefficient change parameter, the first mode is selected in step S7 when the change amount ΔLV within the set time is less than the threshold change amount ΔLVth, and the second mode is selected in step S8 when the change amount ΔLV is equal to or greater than the threshold change amount ΔLVth. When the lead vehicle speed vl is used as the coefficient change parameter, the first mode is selected in step S7 when the lead vehicle speed vl is less than the threshold vehicle speed vlth, and the second mode is selected in step S8 when the lead vehicle speed vl is equal to or greater than the threshold vehicle speed vlth.

When the first mode is selected, it is determined in step S9 whether the mode is being switched. When the mode is not being switched, that is, when the mode switching is completed, the first weighting coefficient K is set to 1 in step S10. When the mode is being switched, the change gradient α is determined in step S11 based on the current lead vehicle speed vl, the current inter-vehicle distance L, and the current steering angle δ using the change gradient determination function α(vl, L, δ) as described above, and the first weighting coefficient K is gradually increased to 1 in step S12 according to the change gradient α.

When the second mode is selected, similarly to the case where the first mode is selected, it is determined in step S13 whether the mode is being switched. When the mode is not being switched, the first weighting coefficient K is set to the specific value Ks, that is, 0 or x (0<x<1) in step S14. When the switching is in progress, the change gradient α is determined in step S15, and in step S16, the first weighting coefficient K is gradually decreased to the specific value Ks according to the change gradient α.

After the first weighting coefficient K is determined, in step S17, the second weighting coefficient (1−K) is determined and the target turning curvature ε* is determined by obtaining the weighted sum of the point-of-interest curvature ε1* and the spline curvature ε2* based on the first weighting coefficient K and the second weighting coefficient (1−K) according to the above equation.

Subsequently, in step S18, the inter-vehicle distance deviation ΔL, which is a deviation of the inter-vehicle distance L at the current time from the determined target inter-vehicle distance L*, is specified, and in step S19, the braking-driving force Fd/b to be generated is determined based on the inter-vehicle distance deviation ΔL in accordance with the PD feedback control law. Information about the braking-driving force Fd/b is transmitted to the braking-driving ECU 40 in step S20. Subsequently, in step S21, the target steering angle δ*, which is the steering angle δ of the front wheel 10f to be realized, is determined based on the determined target turning curvature ε*, and information about the target steering angle δ* is transmitted to the steering ECU 42 in step S22.

What is claimed is

1. An autonomous driving vehicle following a lead vehicle, comprising a controller,
wherein the controller is configured to determine a target turning index based on a relative position between an own vehicle and the lead vehicle at each point in time, the target turning index being a target of a turning index of the own vehicle, the lead vehicle leading the own vehicle,
wherein the controller is configured to steer a wheel based on the target turning index, and
wherein the controller is configured to determine the target turning index at a certain point in time by a weighted sum of (a) a first turning index determined based on the relative position to the lead vehicle at the certain point in time and (b) a second turning index determined based on a travel trajectory of the lead vehicle up to the certain point in time.

2. The autonomous driving vehicle according to claim 1,
wherein, when determining the second turning index, the controller is configured to estimate the travel trajectory of the lead vehicle based on the relative position to the lead vehicle and a change of a traveling position and a direction of the own vehicle at each point in time.

3. The autonomous driving vehicle according to claim 1,
wherein the weighting between the first turning index and the second turning index is changeable in determining the target turning index.

4. The autonomous driving vehicle according to claim 3,
wherein the weighting between the first turning index and the second turning index is changed based on reliability of the second turning index.

5. The autonomous driving vehicle according to claim 4,
wherein the reliability is estimated based on a change amount of a traveling position of the lead vehicle.

6. The autonomous driving vehicle according to claim 3,
wherein the weighting between the first turning index and the second turning index is changed based on a traveling speed of the lead vehicle.

7. The autonomous driving vehicle according to claim 3,
wherein, in determining the target turning index, a first mode and a second mode are set to be switchable so that the first mode has a smaller weighting of the second turning index than the second mode.

8. The autonomous driving vehicle according to claim 7,
wherein the first mode is adopted when the reliability of the determined second turning index is less than a set level, and the second mode is adopted when the reliability of the determined second turning index is equal to or greater than the set level.

9. The autonomous driving vehicle according to claim 8,
wherein the reliability of the second turning index is estimated based on a change amount of a traveling position of the lead vehicle.

10. The autonomous driving vehicle according to claim 7,
wherein the first mode is adopted when a traveling speed of the lead vehicle is less than a set speed, and the second mode is adopted when the traveling speed of the lead vehicle is equal to or greater than the set speed.

11. The autonomous driving vehicle according to claim 7,
wherein the weighted sum is a sum of a product of the first turning index and a first weighting coefficient and a product of the second turning index and a second weighting coefficient, where the sum of the first weighting coefficient and the second weighting coefficient is 1.

12. The autonomous driving vehicle according to claim 11,
wherein, in the first mode, the first weighting coefficient is set to 1 and the second weighting coefficient is set to 0.

13. The autonomous driving vehicle according to claim 12,
wherein, in the second mode, the first weighting coefficient is set to 0 and the second weighting coefficient is set to 1.

14. The autonomous driving vehicle according to claim 12,
wherein, in the second mode, the first weighting coefficient is set to a first set value less than 1 and the second weighting coefficient is set to a second set value greater than 0.

15. The autonomous driving vehicle according to claim 7,
wherein the weighting between the first turning index and the second turning index is gradually changed in the switching between the first mode and the second mode.

16. The autonomous driving vehicle according to claim 15,
wherein a gradient of the gradual change is determined by the traveling speed of the own vehicle or the lead vehicle, an inter-vehicle distance between the own vehicle and the lead vehicle, or a steering amount of the wheel.
